(19) United States
(12) Patent Application Publication
(10) Pub. No.: US 2016/0218608 A1
(43) Pub. Date: Jul. 28, 2016

(54) TECHNIQUE FOR REDUCING COGGING IN CLOSED TRACK LINEAR MOTORS

(71) Applicant: ROCKWELL AUTOMATION TECHNOLOGIES, INC., Mayfield Heights, OH (US)

(72) Inventor: John Floresta, Commack, NY (US)

(21) Appl. No.: 14/604,178

(22) Filed: Jan. 23, 2015

(51) Int. Cl. H02K 41/02

(52) U.S. Cl. CPC H02K 41/02

(57) ABSTRACT

A linear controlled motion system includes a track having at least one mover mounted to the track and effective for receiving articles at one location and transporting the articles to another location. The system includes at least one magnetic linear motion motor for providing a magnetic field effective for moving each mover in a controlled motion along the track. To reduce the cogging effect of the magnetic linear motion motor, at least one bridge element is disposed between the teeth of the motor. For example, slots may be formed in the top portions of each tooth, and individual bridge elements may be slid into the slots. The bridge elements may be made of a material having a relatively high magnetic permeability to reduce the cogging effects of the motor.

### CROSS-REFERENCE TO RELATED APPLICATIONS

U.S. Pat. No. 6,844,651 issued on Jan. 18, 2005, entitled “Encapsulated Armature Assembly and Method of Encapsulating an Armature Assembly,” is hereby incorporated by reference in its entirety for all purposes.

### BACKGROUND

The present disclosure relates generally to controlled motion systems and, more specifically, to controlled motion systems that utilize electromagnetic linear motors and a technique of reducing cogging in such motors.

This section is intended to introduce the reader to various aspects of art that may be related to various aspects of the present disclosure, which are described and/or claimed below. This discussion is believed to be helpful in providing the reader with background information to facilitate a better understanding of the various aspects of the present disclosure. Accordingly, it should be understood that these statements are to be read in this light, and not as admissions of prior art.

There are many processes that benefit from providing the controlled motion of one object relative to another. For example, assembly lines have been used for well over 100 years to facilitate rapid and efficient production. In a typical assembly line, an article being manufactured moves from one station to another, typically via a conveyor belt or by some other motorized means. As the semi-finished article moves from one work station to another, parts are added or processes are performed until the final product is completed. In addition to this type of assembly automation, controlled motion systems may also be used for packaging, transporting objects, machining, etc. Conveyor belts typically use an endless belt that is stretched between a rotary motor and one or more idlers, which results in a relatively high number of moving parts and associated mechanical complexity. Moreover, each item on a conveyor belt necessarily moves at the same speed and in the same spaced apart relationship relative to other items on the conveyor belt. Similarly, ball screws and many other types of linear motion systems also rely upon rotary motors to produce linear motion, and they suffer from similar problems.

The application of controlled electromagnetic motion systems to a wide variety of processes, such as those mentioned above, provides the advantage of increasing both the speed and flexibility of the process. Such controlled motion systems may use linear motors that employ a magnetic field to move one or more elements along a path. The movable element is sometimes known as a carriage, pallet, tray, or mover, but all such movable elements will be referred to here collectively as a “mover.” Such linear motors reduce or eliminate the need for gear heads, shafts, keys, sprockets, chains and belts often used with traditional rotary motors. This reduction of mechanical complexity may provide both reduced cost and increased speed by virtue of reducing inertia, compliance, damping, friction and wear normally associated with more conventional motor systems. Further, these types of controlled motion systems may also provide greater flexibility than rotary motor systems by allowing each individual mover to be independently controlled along its entire path.

Electromagnetic linear motor systems typically have some sections that are straight and some sections that are curved, so that the movers can follow the path best suited for the particular application. Indeed, it should be appreciated that the term “linear” as used herein is meant to refer to electromagnetic motor systems that use electric motors that have their stators and rotors “unrolled” so that instead of producing a torque or rotation, they produce a force along their length. Hence, a linear controlled motion system may include not only straight portions, but also portions that curve side to side, upwardly, or downwardly, to form a path to move a mover from one position to another, while still being considered to be formed from “linear” motor sections (as opposed to rotary motors).

In fact, it is because electromagnetic linear motors have both straight sections and curved sections, such as the linear motor disclosed in U.S. Pat. No. 6,803,681 incorporated by reference herein, that certain problems arise. Specifically, the straight sections and the curved section represent two related, but distinct, motor topologies, and these different motor topologies tend to produce different cogging forces. Cogging force is a disturbance in the magnetic field generated by the stator of the linear motor. It results from variations in the reluctance of the motor air gap as the magnets of the motors pass over the stator. The magnets will always seek to locate in their preferred magnetic positions over the magnetically permeable teeth, which are the positions of minimal reluctance, in the direction of motion. The presence of the teeth, and particularly the slots between the teeth that are present to allow the electromagnetic coil to be wound around each tooth, creates air gap reluctance variation in the stator. For this reason, motor designers typically try to minimize the slot opening between teeth to minimize the variation in air gap reluctance.

However, as mentioned above, the straight sections and the curved sections of a linear motor have distinct topologies relative to cogging performance. In other words, with regard to cogging force and the developed motor force, each topology performs uniquely due to the differences in interaction between the magnetic mover and the respective stators. This makes optimization of the cogging force extremely difficult. For example, the air gap between the magnetic mover and the stator teeth is constant when interacting with a straight section, but the air gap varies when interacting with a curved section, particularly if the curved section does not maintain a constant radius. Common techniques for reducing cogging in permanent magnetic motors, e.g., pulse shifting, pulse shaping, pulse scewing, adjust poll count, etc., are largely ineffective in trying to find a solution that is optimal for both straight sections and curved sections. In other words, optimizing one topology typically means worsening the cogging performance of the other topology. Accordingly, it is desirable to have a technique that improves the cogging performance of both straight sections and curved sections of an electromagnetic linear motor.

### SUMMARY

A summary of certain embodiments disclosed herein is set forth below. It should be understood that these aspects are presented merely to provide the reader with a brief summary of these certain embodiments and that these aspects are not intended to limit the scope of this disclosure. Indeed, this disclosure may encompass a variety of aspects that may not be set forth below.

It has been found that by bridging the slots between teeth on the stator with a magnetically permeable material, a substantial improvement of cogging force can be achieved. The bridging of the teeth reduces the variation in air gap reluctance and thereby reduces the cogging force for both straight sections and curved sections.

### BRIEF DESCRIPTION OF THE DRAWINGS

Various aspects of this disclosure may be better understood upon reading the following detailed description and upon reference to the drawings in which:

FIG. 1 is a schematic representation of a linear controlled motion transport system including a linear magnetic motor system, a track formed from at least two track sections, including both straight sections and curved sections, and having at least one mover effective for moving along the track;

FIG. 2 is a schematic illustration of a side view of a track section of the linear motion track of FIG. 1 showing a plurality of electromagnet coils coupled to a stator and a mover mounted for movement along the track section;

FIG. 3 is a schematic illustration of a perspective view of a mover having reaction elements mounted thereon which cooperate with the activation elements positioned along the track of FIG. 1 and further showing a control sensor for providing a signal for use by a control system in moving the mover along the track;

FIG. 4 is a schematic illustration showing gaps between adjacent teeth and between the two adjacent track sections that can create a disturbance, change, or weakening in the magnetic field;

FIG. 5 is an illustration of a block diagram of an example of the control system interacting with the motor system and positioning system of the control circuitry;

FIG. 6 is a schematic illustration of a perspective view of a portion of a stator of a linear motor having magnetically permeable bridge elements that are insertable between adjacent teeth of the stator; and

FIG. 7 is a schematic illustration of a side view of the stator of FIG. 6 showing the magnetically permeable bridge elements inserted between adjacent teeth on the stator.

### DETAILED DESCRIPTION OF SPECIFIC EMBODIMENTS

One or more specific embodiments will be described below. In an effort to provide a concise description of these embodiments, not all features of an actual implementation are described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

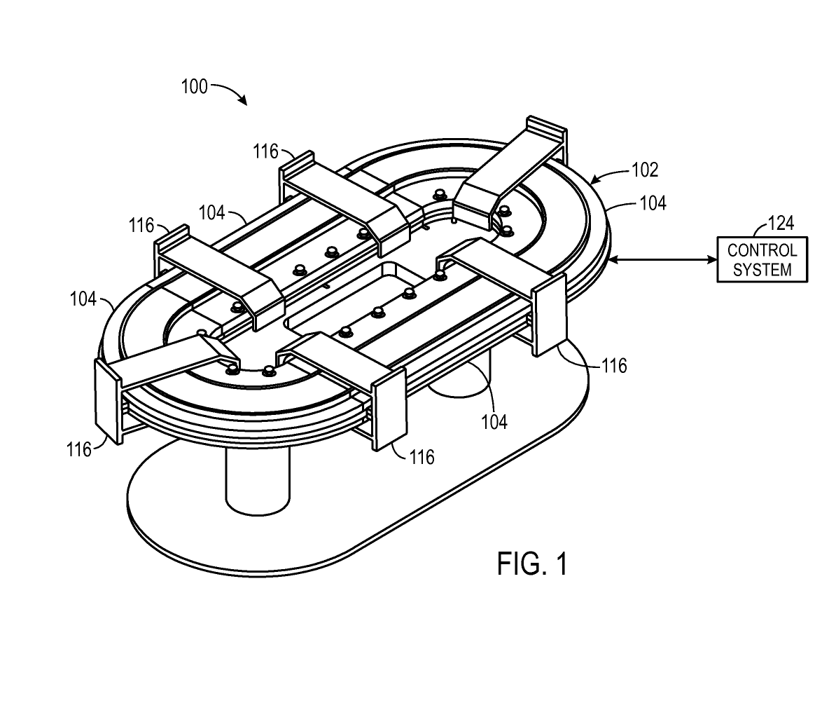

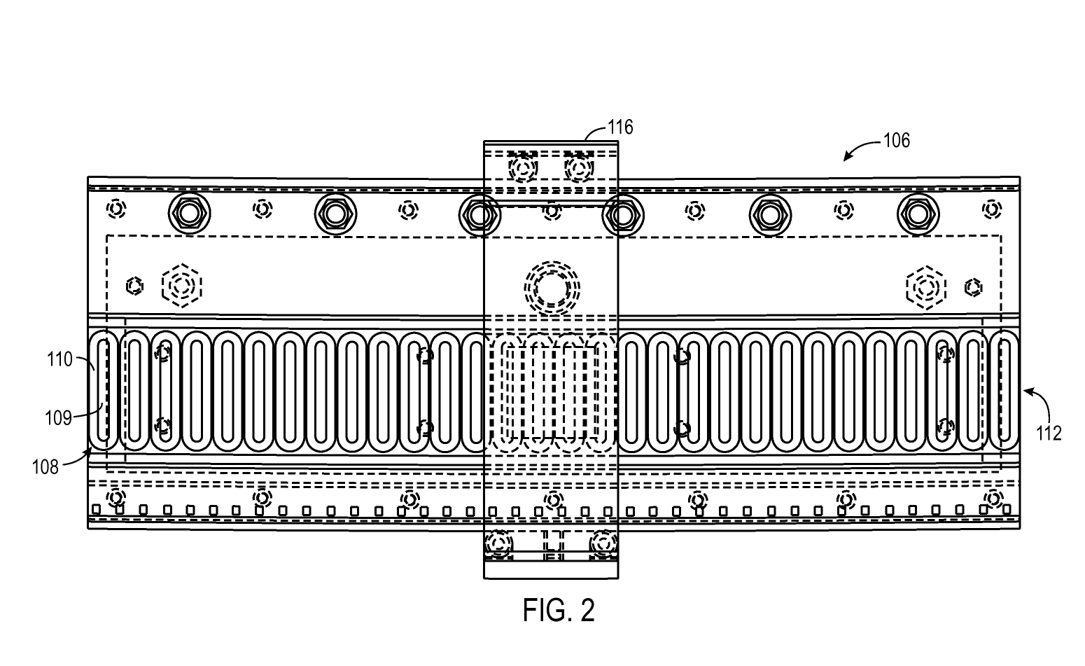

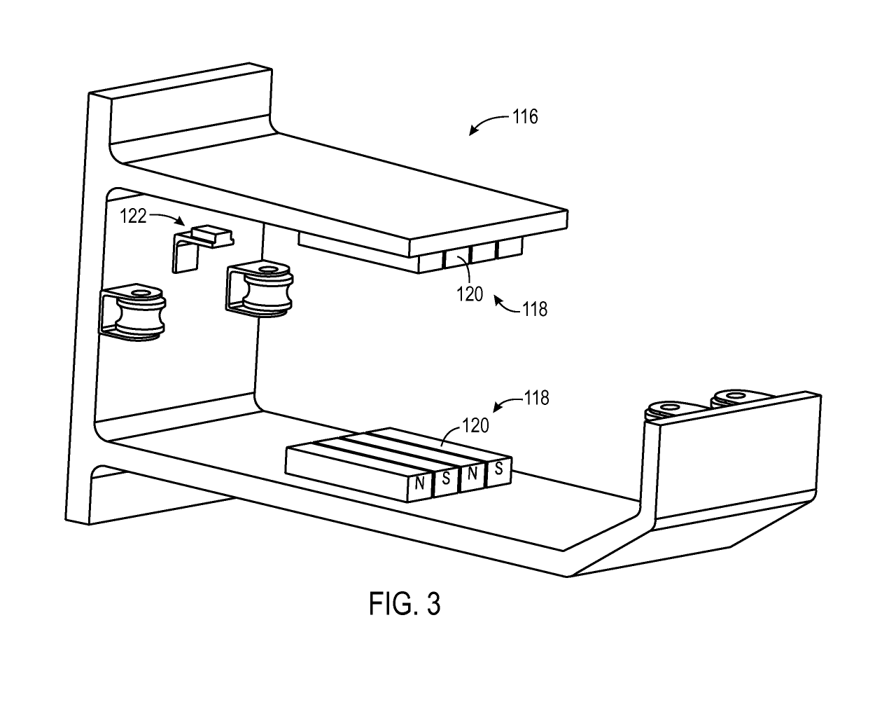

Referring to FIGS. 1 through 4, a schematic representation of a linear controlled motion system 100 is illustrated. It should be appreciated that the term “linear” as used herein is meant to refer to electromagnetic motor systems that use electric motors that have their stators and rotors “unrolled” so that instead of producing a torque or rotation, they produce a force along their length. Hence, a linear controlled motion system 100, such as the oval system illustrated in FIG. 1, may include portions that curve side to side, upwardly, or downwardly, to form a path to move a mover from one position to another, while still being considered to be formed from “linear” motor sections (as opposed to rotary motors).

As illustrated, the linear controlled motion system may include a track 102 formed from two or more interconnected track sections 104 having a magnetic motor system 106 having activation elements 108, such as a plurality of electromagnet coils 110 coupled to teeth 109 of a stator 112 mounted along the track sections 104. The electromagnet coils 110 operate to create an electromagnetic field illustrated by magnetic flux lines 114. Coupled to the track 102 is at least one mover 116 mounted to permit travel along the track 102. Each mover 116 is controlled and may generally move independent of other movers. Reaction elements 118 may include one or more magnets 120, such as rare-earth permanent magnets. The reaction elements 118 on each mover 116 cooperate with the activation elements 108 positioned along the track 102 to produce relative movement therebetween when the activation elements 108 are energized and/or de-energized. Each mover 116 further includes a control sensor 122 that provides a signal for use by a control system 124 for operating the motor system 106 by energizing and/or de-energizing the activation elements 108 positioned along the track 102 thereby producing controlled movement of each mover 116.

In one embodiment, as illustrated in FIG. 5, the controlled motion system 100 includes a positioning system 126 that employs a plurality of linear encoders 128 spaced at fixed positions along the track 102, and that cooperate with the control sensor 122 mounted on each mover 116 to provide signals to the control system 124 for sensing each mover's position along the track 102. Each control sensor 122 may include a linear encoder, such as an “incremental absolute” position encoder, that is coupled to the control system 124, and that operates to sense and count incremental pulses (or digitize sine/cosine signals to create these pulses) after a mover 116 has traveled past a reference point (not shown)).

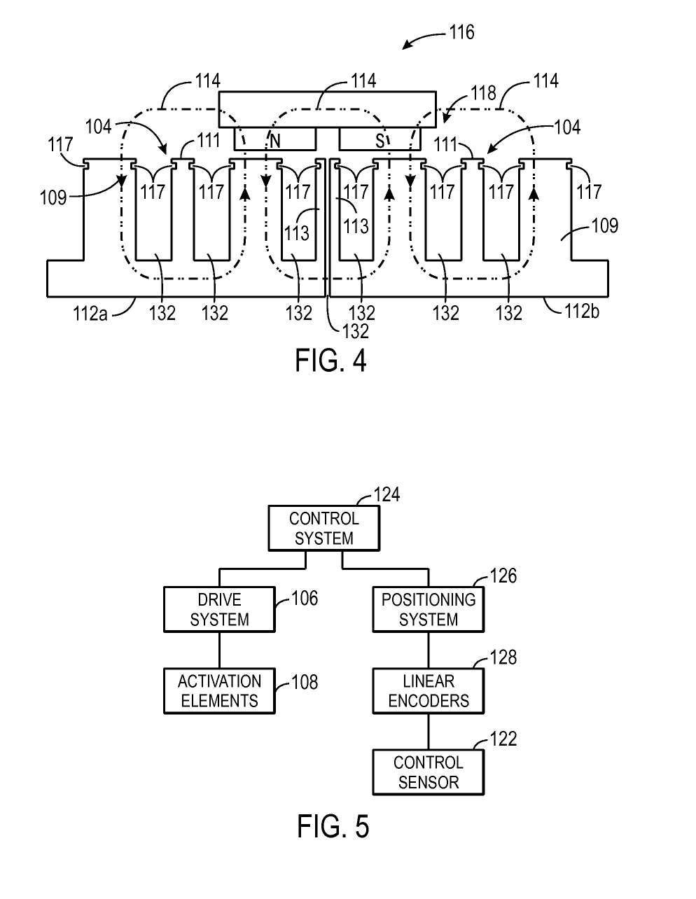

Referring to FIG. 4, a portion of the track 102 is shown having two adjacent interconnected track sections 104 and a plurality of electromagnetic coils 110 formed along stators 112 that are mounted along the track sections 104, and that operate to create an electromagnetic field mounted along each track section 104, as illustrated by magnetic flux lines 114 forming a closed loop with the mover 116 and the adjacent track sections 104. As shown, a gap 132, such as an air gap, exists between adjacent teeth 109 and 111 and between the end teeth 113 of the track sections 104. A change in the air gap reluctance occurs across each of the gaps 132. This change in the air gap reluctance creates a cogging force that is problematic in that it may lead to lost performance, noise, false readings, or unwanted interaction of movers along the track 102. Further, when a mover 116 experiences a change or weakening in the magnetic field during operation of the control motion system 100, the control sensor 122 may sense this change or weakening such that the counting process performed by the control system 124 may be lost or the pulse counting disrupted. Such disruptions may also require the movers 116 to be driven back to a reference point or home position to initialize or reset the counting process.

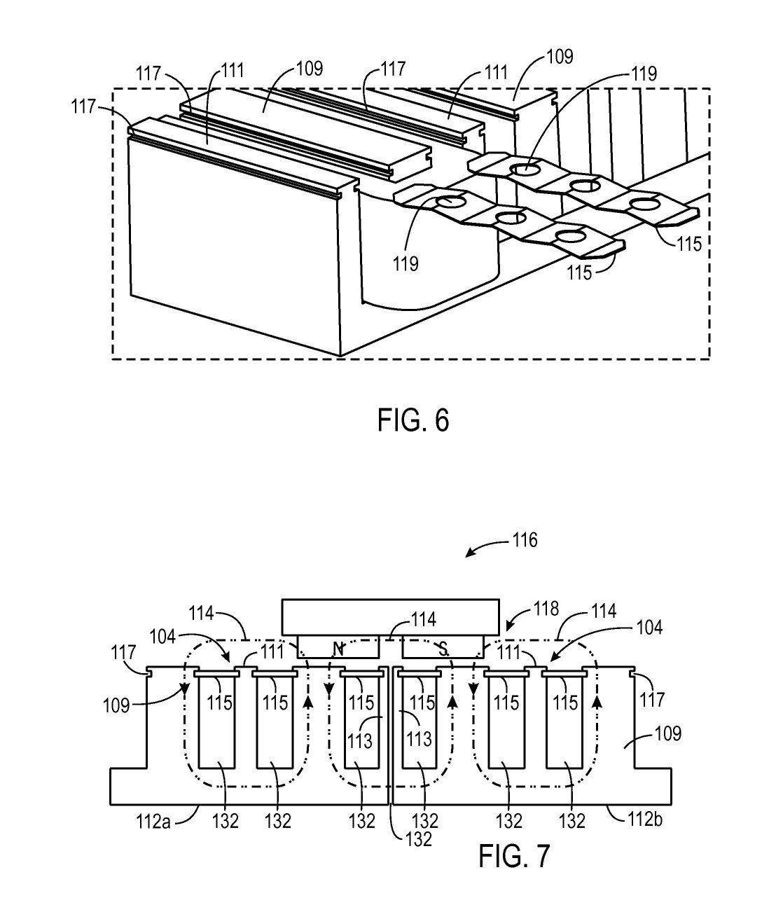

To address this concern, bridge elements 115 may be inserted between adjacent teeth 109, 111, and 113 to reduce the variation in air gap reluctance and, thereby, reduce the cogging force, as illustrated in FIGS. 6 and 7. To facilitate ease of manufacture, the teeth may include slots 117 that run along the length of the upper portion of each tooth 109, 111, and 113. The slots 117 are advantageously sized so that the bridge elements may be slid into the slots 117 of adjacent teeth and subsequently held in place by a sufficient amount of frictional force. As illustrated in FIG. 6, the bridge elements 115 may have a corrugated shape and may include one or more apertures 119. The corrugated shape may facilitate the placement and holding of the bridge elements 115 while the apertures 119 may facilitate encapsulation of the assembly as described in detail in U.S. Pat. No. 6,844,651. However, it should be appreciated that the bridge elements 115 need not be corrugated or contain apertures. Indeed, the bridge elements 115 may be relatively flat with no apertures.

Advantageously, the bridge elements 115 are made of a material having good magnetic permeability, such as materials having a magnetic permeability of 5.0×10⁻³μ or greater. Materials of this type include electrical steel (5.0×10⁻³μ), iron (6.3×10⁻³μ (99.6% pure)), permalloy (1.0×10⁻²μ), cobalt-iron (2.3×10⁻²μ), nanoperm (1.0×10⁻¹μ), pure iron (2.5×10⁻¹μ (99.95% pure or greater)), or metaglas (1.26×10μ). Materials of this type are vastly superior to materials having a lower magnetic permeability, such as nickel, stainless steel, or air. Indeed, in one example, a motor using iron bridge elements 115 exhibited a small decrease in force of about 10-15%, but the cogging was significantly decreased by about 50% as compared to a motor having no bridge elements. However, it is believed that the use of such bridge elements 115 made of materials of the type described above will result in small decreases in force of typically 1%-10% and result in decreases in cogging of at least 20% as compared to a motor having no bridge elements.

When the bridge elements 115 are inserted between the teeth 109, 111 and 113 of the stator 112, a percentage of the magnetic flux lines 114 flow through the bridge elements 115. As a result, the mover 116 encounters a magnetic field that is more consistent as it moves along the stator 112, thus reducing the cogging effects. Of course, as mentioned above, the use of the magnetically permeable bridge elements 115 to reduce the cogging effects also tends to cause some amount of decrease in the moving force provided by the motor. Hence, the bridge elements 115 may be selected and designed to provide the desired balance between reduced force and reduced cogging for any particular motor application. For example, the thickness of the bridge elements 115, the material from which they are made, the thickness of the teeth 109, 111, 113, and the size of the air gaps between the teeth may all be considered in reaching a design that provides the desired force v. cogging characteristics. Typically, suitable bridge elements 115 will have a magnetic permeability as discussed above and they will be less than ⅕ the thickness of the teeth. Indeed, in the example mentioned above, the thickness of the bridge elements 115 were about 1/10 the thickness of the teeth.

Alternatively, a solid sheet of magnetically permeable material, such as those materials mentioned above, may be used as a bridge element instead of the plurality of individual bridge elements 115. Though not shown in the figures, such a sheet may be disposed on top of the teeth 109, 111, 113. The sheet may be affixed to the teeth in any suitable manner, e.g., fasteners, adhesive, etc. Similar to the variables discussed above with respect to the individual bridge elements 115, the thickness of the sheet and the material from which it is made may be selected relative to the characteristics of the stator 112 to provide the desired force v. cogging characteristics.

The specific embodiments described above have been shown by way of example, and it should be understood that these embodiments may be susceptible to various modifications and alternative forms. It should be further understood that the claims are not intended to be limited to the particular forms disclosed, but rather to cover all modifications, equivalents, and alternatives falling within the spirit and scope of this disclosure.

What is claimed is:

1. A controlled motion system comprising:
a track comprising a linear magnetic motor having a stator having a plurality of teeth, wherein at least some of the plurality of teeth include electromagnetic coils configured to produce a magnetic flux;
one or more movers mounted to move along the track by utilizing the magnetic flux; and
at least one bridge element disposed between the teeth of the stator, the at least one bridge element being made of a material having a magnetic permeability of 5.0×10⁻³μ or greater.

2. The controlled motion system of claim 1, wherein the at least one bridge element comprises a sheet of magnetically permeable material disposed on top of the plurality of teeth.

3. The controlled motion system of claim 1, wherein the at least one bridge element comprises a plurality of individual bridge elements, each of the plurality of individual bridge elements being disposed between respective adjacent teeth of the stator.

4. The controlled motion system of claim 3, wherein each of the plurality of teeth have a slot formed in a top portion thereof and positioned opposite a slot formed in a top portion of a respective adjacent tooth, wherein each slot is configured to accept an edge of a respective individual bridge element.

5. The controlled motion system of claim 3, wherein each of the plurality of individual bridge elements comprises an elongated strip of magnetically permeable material.

6. The controlled motion system of claim 5, wherein the elongated strip is substantially flat.

7. The controlled motion system of claim 5, wherein the elongated strip is corrugated.

8. The controlled motion system of claim 5, wherein the elongated strip comprises one or more apertures therein.

9. The controlled motion system of claim 1, wherein the at least one bridge element provides a substantially consistent magnetic field between the mover and plurality of teeth over which the mover moves.

10. The controlled motion system of claim 1, wherein the at least one bridge element is less than ⅕ as thick as each of the plurality of teeth.

11. The controlled motion system of claim 1, wherein the at least one bridge element is made from electrical steel, iron, permalloy, cobalt-iron, nanoperm, pure iron, or metaglas.

12. The controlled motion system of claim 1, wherein the at least one bridge element reduces cogging by at least 50% as compared to a similar controlled motion system having no bridge element.

13. The controlled motion system of claim 1, wherein the at least one bridge element reduces cogging by at least 20% as compared to a similar controlled motion system having no bridge element.

14. The controlled motion system of claim 1, wherein the track includes straight sections and curved sections.

15. A stator for a controlled motion system comprising;
a stator section comprising:
a base having a plurality of teeth;
a plurality of electromagnetic coils disposed about at least some of the plurality of teeth; and
at least one bridge element disposed between the teeth of the stator, the at least one bridge element being made of a material having a magnetic permeability of 5.0×10⁻³μ or greater.

16. The stator of claim 15, wherein the at least one bridge element comprises a sheet of magnetically permeable material disposed on top of the plurality of teeth.

17. The stator of claim 15, wherein the at least one bridge element comprises a plurality of individual bridge elements, each of the plurality of individual bridge elements being disposed between respective adjacent teeth of the stator.

18. The stator of claim 17, wherein each of the plurality of teeth have a slot formed in a top portion thereof and positioned opposite a slot formed in a top portion of a respective adjacent tooth, wherein each slot is configured to accept an edge of a respective individual bridge element.

19. The stator of claim 17, wherein each of the plurality of individual bridge elements comprises an elongated strip of magnetically permeable material.

20. The stator of claim 19, wherein the elongated strip is substantially flat.

21. The stator of claim 19, wherein the elongated strip is corrugated.

22. The stator of claim 19, wherein the elongated strip comprises one or more apertures therein.

23. The stator of claim 15, wherein the at least one bridge element is less than ⅕ as thick as each of the plurality of teeth.

24. The stator of claim 15, wherein the at least one bridge element is made from electrical steel, iron, permalloy, cobalt-iron, nanoperm, pure iron, or metaglas.

25. The stator of claim 15, wherein the stator section comprises a straight section of a linear magnetic motor.

26. The stator of claim 15, wherein the stator section comprises a curved section of a linear magnetic motor.
